(19) United States
(12) Patent Application Publication
(10) Pub. No.: US 2005/0060159 A1
(43) Pub. Date: Mar. 17, 2005

(54) Text transcription with correlated image integration

(76) Inventors: Richard Jackson, Whitefish, MT (US); David Bardwick, Missoula, MT (US); Jack Blanchard, Palm Beach Gardens, FL (US)

Correspondence Address: Burkhart & Burkhart;Patent Attorneys, 940 Dakota Avenue, Whitefish, MT, 59937, US

(21) Appl. No.: 10/666,738

(22) Filed: Sep. 17, 2003

(51) Int. Cl. G10L 11/00

(52) U.S. Cl. 704/275

(57) ABSTRACT

A method of producing a document at a remote typing station using information input from a remote user location is provided. Voice and image data are transmitted from a user location, transcribed and correlated by a typist at a remote typing station, and made available as a finished document.

### FIELD OF THE INVENTION

The invention generally relates to methods for producing documents from remotely-received information. More specifically, the invention relates to a dictation and transcription method in which various system components and participants can be located remotely from one another.

### DESCRIPTION OF RELATED ART

The image of a secretary clutching a steno pad, pencil poised to receive dictation from a pensive executive, is well-ingrained in our collective business psyche. The advantages of extemporaneous dictation, later transcribed, proofread, and edited, stand virtually unquestioned. However, the disadvantages of live transcription are equally well-known. The costs involved in hiring and retaining a person with shorthand skills are relatively high, as are the risks that such skills will be most sorely needed when the person possessing them is either sick or on vacation.

As a consequence, soon after the human voice was first successfully recorded and played back on a wax cylinder, inventive ingenuity began to be applied in the production of ever more sophisticated and complex systems for dictating and transcribing documents. Besides the aforementioned cylinders, wire recorders, cassettes, mini cassettes, and more recently digital technology have been used to record dictation for later transcription.

It has also been suggested that remote communications devices, such as the telephone, could be used in dictation systems. One such application is described in U.S. Pat. No. 4,856,069 to Kolodny et al. This patent is directed to a typing station at a remote location having a central processing unit and a terminal is interconnected with an information storage and retrieval system via a single telephone line. A typist at the remote location depresses a foot pedal associated with the central processing unit and controls shared transmission of audio messages and digital data between the typing station and the information storage and retrieval system. When the foot pedal is depressed, audio information is transmitted from the information storage and retrieval system at a central location to the typing station at the remote location. When the foot pedal is released, digital data defining previously transcribed audio information which is stored in the central processing unit is transmitted to the information storage and retrieval system via the single telephone line.

Yet another application of telephony to dictation and transcription is set forth in U.S. Pat. No. 4,955,051 to Sato. This patent is directed to a telephone dictating apparatus operable in record, playback, stop and rewind modes. The apparatus involves the conversion of DTMF signals, given by depressing four push-buttons arranged in one of three longitudinal lines, to four mode signals. The mode signals are in the same order as the four push-buttons which have one-to-one correspondence to four mode setting positions associated with a tape running system. The tape running system includes a slide switch for switching modes which is employed in a hand microphone for dictation or the like.

As can be appreciated from these patents, the state of the art is such that many disadvantages of basic in-person dictation persist. Known systems still require simultaneous presence of the dictation source and the transcriber, or else entail cumbersome connections. Furthermore, known systems have no provision for the contemporaneous incorporation of image data in a text file. If a system user is capturing images related to the subject of dictation, the images are compiled separately. Once a document is produced based upon the dictation, images must then be viewed and then correlated with the text, taking additional time and introducing a likelihood of errors.

It can therefore be seen that the need exists for a method of dictation and image corelation which eliminates the requirement of physical proximity between the dictation source and the transcription location without sacrificing immediacy and speed of operation.

### SUMMARY OF THE INVENTION

The present invention provides a method of producing a document at a remote typing station using information input from a remote user location. First, a telephonic connection is established between a user location and a central computer. Next, information from the user location is entered into the central computer via the telephonic connection. The input information is then received and stored in the central computer. The typing station polls the central computer for jobs via a telephonic connection is established between the typing station and the central computer. At the typing station, input information is retrieved from the central computer and a document is produced using the information. The document is then transmitted from the typing station to the central computer via the telephonic connection, where the information is received and stored. Next, a telephonic connection is established between the user location and the central computer, and the document is transmitted from the central computer to the user location.

A proofreading function can be added to enhance the functionality of the basic system. In this embodiment, a telephonic connection is established between a user location and a central computer. Next, information from the user location is entered into the central computer via the telephonic connection. The input information is then received and stored in the central computer, which then generates a notification signal to a remote typing station indicating that information has been received. Next, a telephonic connection is established between the typing station and the central computer. At the typing station, input information is retrieved from the central computer and a document is produced using the information. The document is then transmitted from the typing station to the central computer via the telephonic connection, where the information is received and stored. The central computer is then used to generate a notification signal to a remote proofreading station indicating that the document has been received. A telephonic connection is next established between the proofreading station and the central computer, whereafter the document is retrieved at the proofreading station and processed to produce a final document. The proofreader can also determine the length of the reviewed final document. The final document is then transmitted from the proofreading station to the central computer, where it is received and stored. Next, a telephonic connection is established between the user location and the central computer, and the document is transmitted from the central computer to the user location. The central computer is then used to calculate typist and proofreader compensation, generate typist and proofreader compensation records based upon the length of the reviewed final document, calculate user fees, and to generate user billing records based upon the length of the reviewed final document. Next, a telephonic connection is established between the user location and the central computer, and the document is transmitted from the central computer to the user location.

### BRIEF DESCRIPTION OF THE DRAWINGS

FIG. 1 is a schematic illustration of a remote dictation and transcription system.

FIG. 2 is a schematic illustration of another remote dictation and transcription system.

FIG. 3A is the first section of a flow chart illustrating operational aspects of a remote dictation and transcription system.

FIG. 3B is the second section of the flow chart illustrated in FIG. 3A.

FIG. 4 is a flow chart illustrating additional operational aspects of a remote dictation and transcription system.

### DETAILED DESCRIPTION OF THE PREFERRED EMBODIMENT

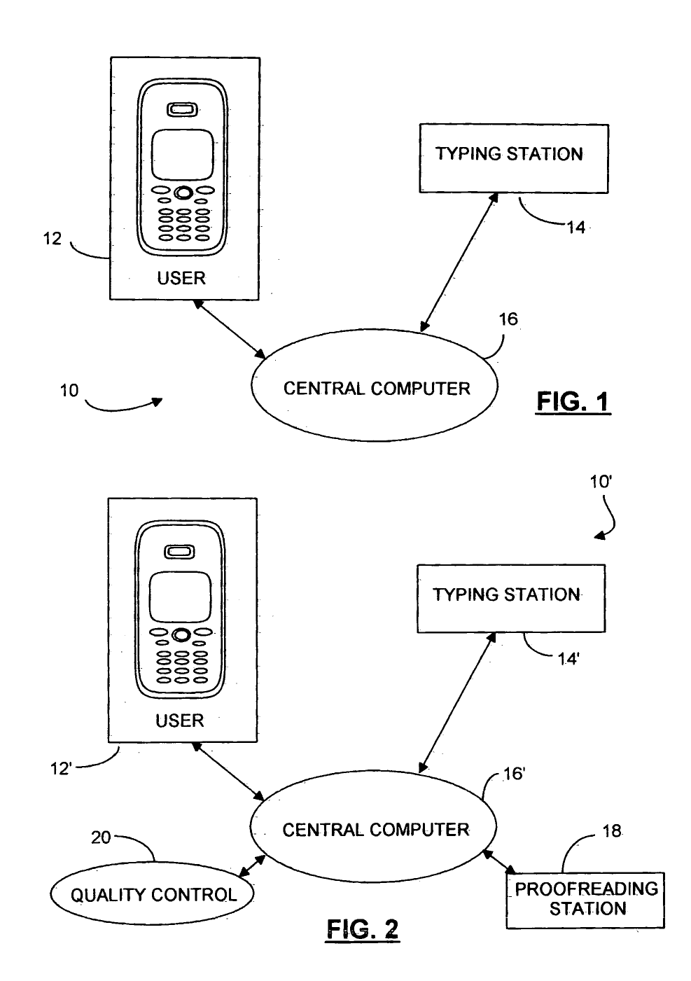

FIG. 1 shows the basic structure of a remote dictation and transcription system 10. The system 10 includes a user 12 and a typing station 14, linked together by a central computer 16. The way in which the present invention implements the linkages and interactions between the user 12 and the typing station 14 via the central computer 16 enable the user to employ the system 10 to produce a finished document from the user's dictation entirely through the user's personal telephone (land-based, cellular, or wireless) and/or personal computer, from any location the user chooses. The user 12 enters information into the central computer 16 via telephone. The central computer 16 converts the information from the user 12 into files that can be stored and retrieved via computer, and then stores the files in a selectively accessible location, for example, a limited-access web page accessed over the internet. A typist at the typing station 14 retrieves the information from the selectively accessible location designated by the central computer 16 via a telephone connection, for example, a modem, DSL, or suitable high-speed connection. The typist converts the information in the files into documents, which the typist then uploads to the selectively accessible location, from which they are sent to the user 12 via the central computer 16.

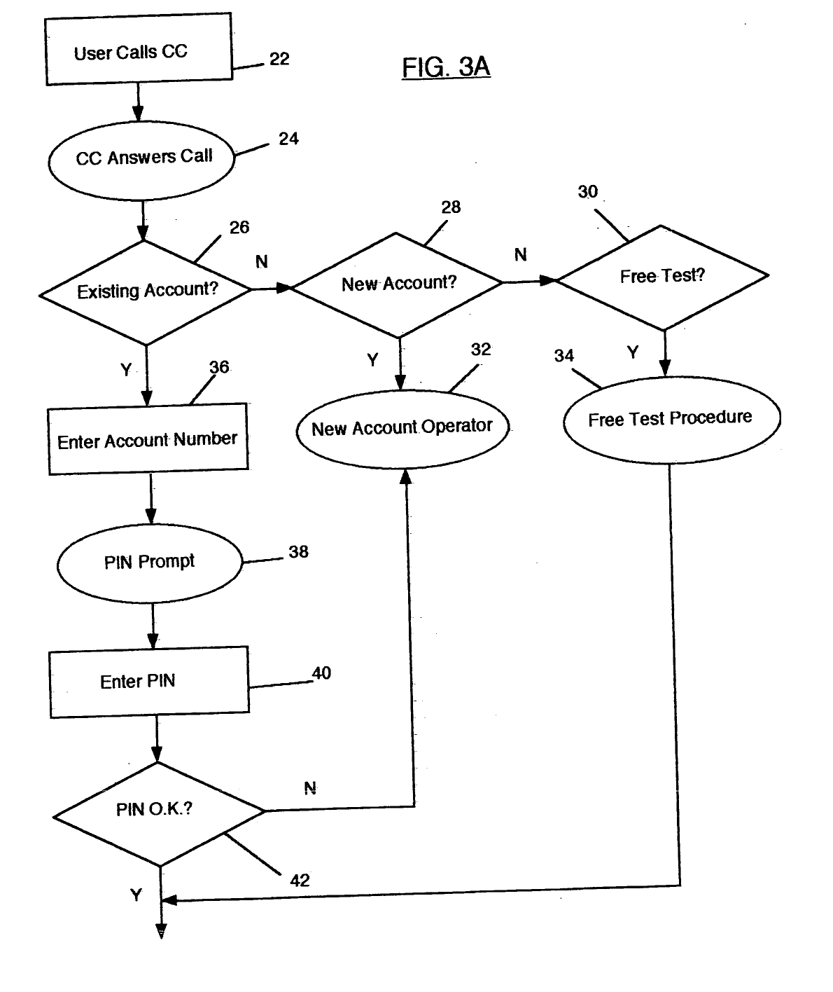

FIG. 2 illustrates a remote dictation and transcription system 10′ similar to that shown in FIG. 1, adding a remote proofreading station 18 to enhance the quality of documents produced by the system 10′. The proofreading station 18 is linked to the system 10′ by way of a selectively accessible location as described above. In operation, the system 10′ is initially similar to that shown in FIG. 1. The user 12′ enters information into the central computer 16′ via telephone. The central computer 16′ converts the information from the user 12′ into files that can be stored and retrieved via computer, and then stores the files in a selectively accessible location, for example, a limited-access web page. A typist at the typing station 14′ retrieves the information from the selectively accessible location designated by the central computer 16′ via a telephone connection, for example, a modem. The typist converts the information in the files into a document, which the typist then uploads to the selectively accessible location. Next, a proofreader at the proofreading station 18 retrieves the document from the selectively accessible location designated by the central computer 16′ via a telephone connection, for example, a modem. The proofreader reviews the document for errors in form and content, noting any corrections to be made, and produces a reviewed document, which the proofreader then uploads to the selectively accessible location. Once corrections have been made, the resulting final reviewed document is uploaded to the selectively accessible location, from which it can be downloaded by the user 12 from the central computer 16.

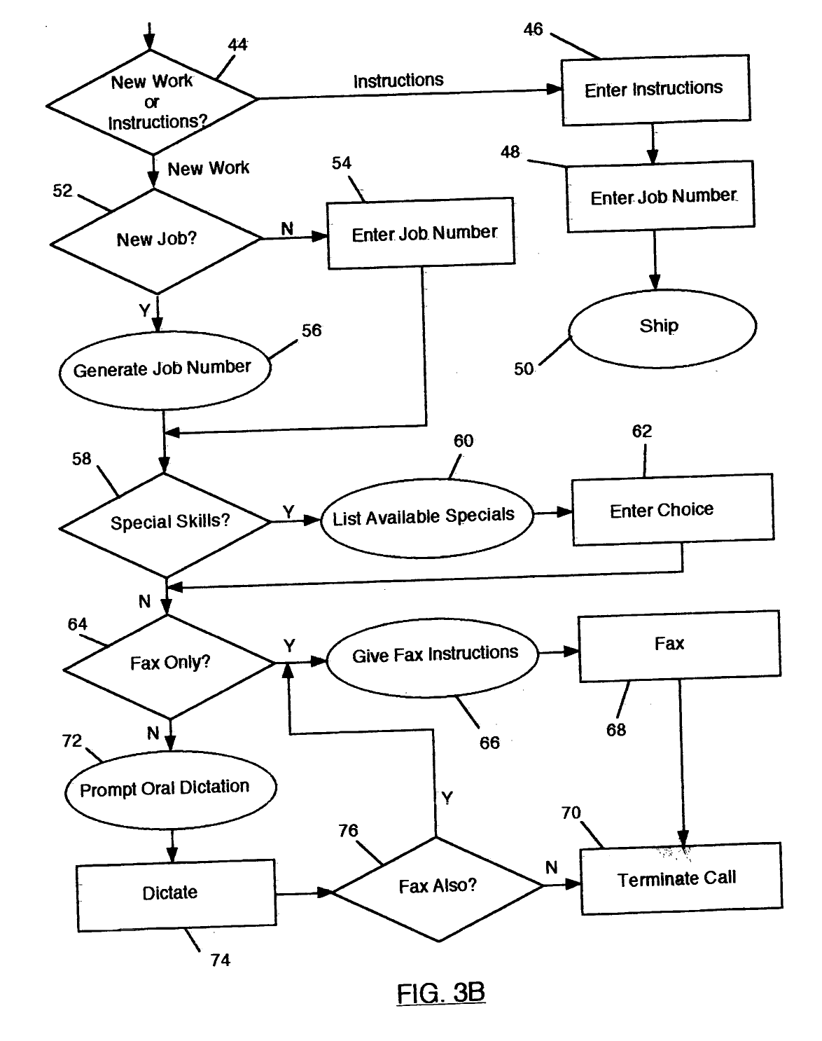

The flow chart in FIGS. 3A and 3B set forth a more detailed process for implementing the systems illustrated previously. The process begins at point 22, when the user calls into the central computer (“CC” in the Figures). Calls are received by the central computer, as indicated at point 24, using known telephony hardware, for example, NMS Communications (NMS) telephony hardware. Other suitable telephony hardware is available from Intel, Brooktrout, and Pilca. Once the call has been answered, the user interacts with the central computer via an IVR interface, which may be programmed in a way known to those of skill in the art to allow the user to select from a variety of menu options. For example, the user may be presented with the option of receiving instructions on use of the system, or to receive sales information, or to log in to the system. The instructional and informational options can be implemented through the use of commercially available software and hardware.

The user log-in option can be accomplished in the following way. The central computer first prompts the user to determine whether the user has an existing account (at point 26), wishes to establish an account (point 28), or wants to try a free test of the system (point 30). If the user wants to establish a new account, the central computer transfers the call to the new account operator, as indicated at point 32, who can obtain from the user the information necessary to set up the account, including the user's name and address, billing preferences, computer hardware and software preferences, etc. If the user wants to sign up for a free test, the central computer gives the user a description of the free test procedure (point 34), after which the user enters the system at a point after a regular user would have entered a PIN number, as will be described in detail.

If, however, the user has an existing account, the user is prompted for, and enters, the account number, as shown at point 36. The central computer checks the entered account number against a master list at point 37. If the account number does not match the any account number on file, the call is forwarded to the new account operator, who resolves the problem with the user. If the account number is found, the user is then prompted for a PIN number (point 38), which the user enters as indicated at point 40. The central computer then checks the PIN entered against that on record for the account entered (point 42). If the PIN does not match the account, the call is forwarded to the new account operator, who resolves the problem with the user.

If the PIN is approved, the user then indicates, as shown at point 44, whether the call has been made to give instructions regarding completed work, or to perform “new work”, i.e., to create or edit a document. If the call has been made to give instructions regarding handling completed work, the user records the instructions (point 46) and enters the job number (point 48), after which the central computer forwards the instructions to the shipping and handling department (point 50). The instructions are recorded by the central computer using the same procedures that are used for dictation, which procedures will be described in detail herein.

If the caller indicates that the call concerns new work, the central computer prompts the user to indicate (at point 52) whether the new work involves a new job, i.e., creating a new document, or editing an existing job. If the new work involves an existing job, the user enters the job number at point 54. If, however, the new work is directed to a new job, the central computer generates a job number at point 56. At point 58, the user is asked if the work requires special typing skills, such as familiarity with medical or technical transcription. If yes, then the central computer lists the available specialties at point 60, and the user selects from the list at point 62.

Next, the user is asked at point 64 to indicate if the information to be entered will be faxed material or oral dictation. If the information to be entered is fax only, the system proceeds to point 66, at which the central computer gives faxing instructions to the user. The user then faxes the information, as indicated at point 68, and the call is terminated at point 70. The central computer stores the faxed information in a machine-readable file, such as a multi page TIF file, for later retrieval and manipulation.

If the information to be entered is oral dictation, the system proceeds to point 72, where oral dictation is prompted, and the user can begin to dictate, as indicated at point 74. At this stage, the central computer operates a program which allows the telephone keypad to perform the functions of a dictation machine handset, while the central computer records the dictation. In a manner known to those of skill in the art, the central computer can be programmed to interpret respective phone pad keystrokes as dictation control commands such as Record, Playback, Pause, Rewind to beginning, Forward to end, Skip ahead 5 seconds, Skip back 5 seconds, Skip ahead half the distance to the end of the dictation, Skip back half the distance to the beginning of the dictation, and Erase from current point forward. All recordings are initially saved in a readily edited voice file format, such as an NMS VOX file, to allow for the manipulation of the information during dictation.

Graphical and/or pictoral information can be added during dictation. It is contemplated that such information can be captured with the use of a hand-held phone incorporating a digital camera. Such devices are available from manufacturers including Sony, Sanyo, Motorola, Ericsson, Nokia, Palm, HP, and Handspring, among others. Voice and image data can be transmitted via service providers such as Sprint, Verizon, T-Mobile, Motorola, AT&T, and Cingular. Since the graphical information is transmitted at the same time and in approximately the same manner as the dictated text, it is “embedded” in real time contemporaneously within the dictated verbal dictation.

Once the user has completed dictation, the system advances to point 76, where the user is prompted for additional faxed material, which would be transmitted in the manner associated with points 66, 68, and 70. After the dictation has been submitted to the system and the user has sent all faxes (if applicable), the user is prompted at point 69 to indicate whether the transmitted information is to be stored for later user revision or submitted for transcription. Once the user has responded, call is terminated at point 70. Also at point 70, if the user indicates that the information is to be submitted for transcription, the central computer converts the voice and/or graphic file to a format that will allow easier playback and transcription of the information. For example, the voice file may be converted to a .WAV file, the image information stored as JPEG files, and then to a RA (RealAudio) file. At this stage, all necessary information about the job is stored in a database, such as a Microsoft Access database file, to allow for use and retrieval of the particulars of the entered information and other data associated with the job. This allows the central computer to place the user and job information in a readily accessible location, such as a secured website, for later processing of the information. For example, the relational database, described as a Microsoft Access database, employed by the central computer could readily be accessed over the world wide web via a web server running suitable software, such as Allaire's Cold Fusion software.

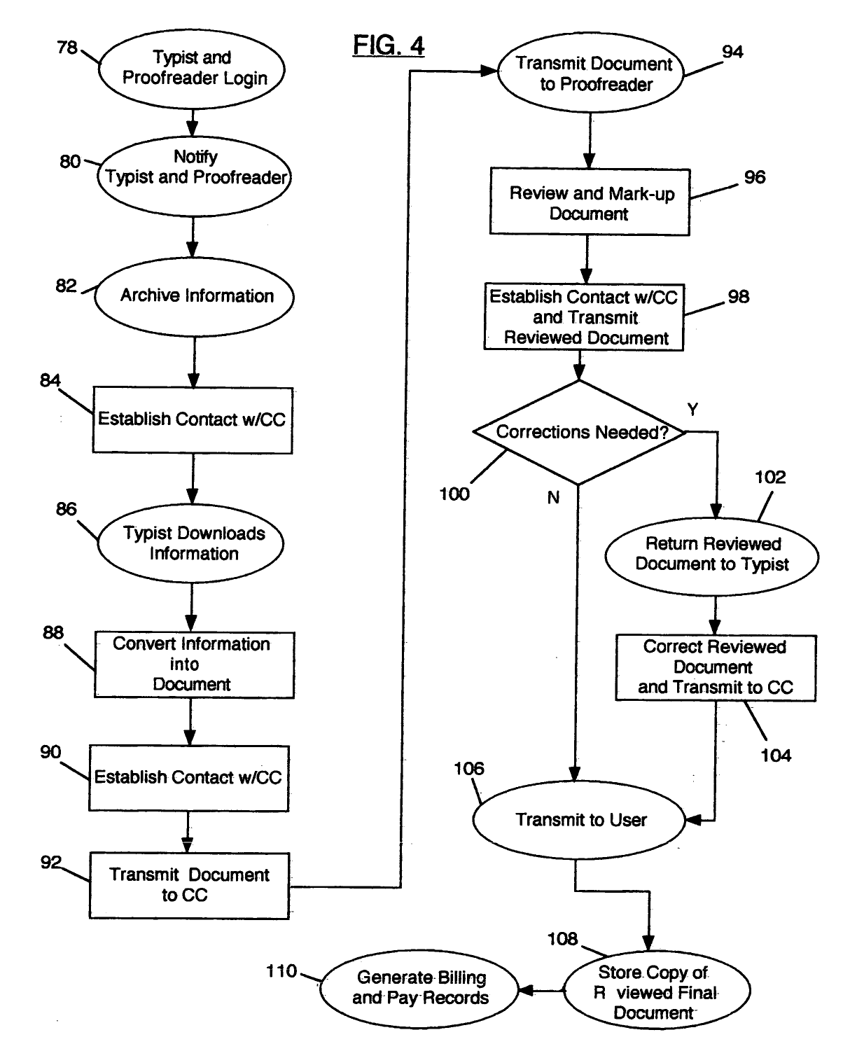

The flowchart set forth in FIG. 4 describes exemplary operational steps of the system after the user has entered information in accordance with FIGS. 3A and 3B. As indicated at point 78, personnel needed to process the user information are logged in to the central computer. This login may be accomplished by establishing an internet connection to a web page through the individual's respective local Internet Service Providers (ISP). Such personnel could include, for example, a typist at a remote typing station, a proofreader at a remote proofreading station, or any other persons having skills suitable to the type of document the user requires. For exemplary purposes, the method will be described with reference to a typist and a proofreader, although it is to be understood that the system is equally useful with multiple processing personnel or a single processing station, such as a typist. It is not necessary for the personnel to log in after the user has entered information. Rather, the personnel can log in and indicate their availability to perform work at any time.

The central computer queries the database to determine the oldest undone job, which would then be assigned to the first available typist. For example, a language such as SQL or DBase could be used to write a sequence of queries, which would be executed to determine the oldest undone job, which would then be assigned to the first available typist.

At point 80, the central computer notifies the typist and proofreader that a job has been assigned to them. In a preferred embodiment, notification is accomplished by providing the typist and proofreader with software that “polls” the central computer, via an internet connection, at predetermined intervals to determine whether a job is ready. At point 82, the central computer archives the user information in the file formats previously described for a predetermined period of time. The redundancy achieved by archiving provides a backup copy in the event that the original file is lost, damaged, or destroyed. It is contemplated that the steps described in points 78, 80, and 82 could be performed simultaneously.

Next, the typist establishes contact with the central computer at point 84. Such contact is telephonic, preferably accomplished by the typist using a web browser to log into a web page as previously set forth and, as indicated at point 86, to download the file or files containing the required information. The download can be accomplished via audio streaming, or multimedia communications using an application such as a REALplayer or Windows Media Player. As indicated at point 88, the typist then converts the information into a document. If the information is in fax form, the typist would simply retype or scan the information from the fax into a word processing format. If the information is in the form of an audio and/or graphical file, such as a RealAudio clip, the typist listens to the file and transcribes the dictation into the word processor format preferred by the user, inserting the graphics files into the document where they were entered by the user. It is contemplated that the typist could control the playback of the dictation with any suitable known mechanism. Alternatively, it is also contemplated that one of skill in the art would recognize that a program could be written to allow the typist to control the playback of the dictation through RealAudio using a foot pedal (commonly used for flight simulator and auto racing games) attached to the game port of the typist's computer. Using a foot pedal thus programmed, the typist can play and pause the playback of the dictation in a manner similar to that used with a conventional dictation apparatus. Other data may also be made available to the typist via the web page. For example, a client address book, sets of uploaded boiler-plate documents, in addition to any faxes attached to the dictation, could be made available on-line to the typist.

Once the typist has completed the document, the typist establishes telephonic contact with the central computer once again as indicated at point 90, e.g., by accessing the previously-described web page, and transmits the document to the central computer (point 92), which may be accomplished by uploading the document to the web page. At location 92, the document is retrieved by the proofreader. This may be accomplished in the same ways that information and document transmittal has been described previously, e.g., via direct downloading from the web page or via e-mail. If a web page is used, the customer's address book, boiler-plate documents and faxed attachments would also be available to the proofreader. At point 96, the proofreader reviews and corrects the document, and performs a word count using a word processing program. The word count can be used to generate pay records and pay statements for the typist and proofreader, and to generate billing records and billing statements for the user. Once the proofreading process is complete, the proofreader, at point 98, establishes contact with the central computer and transmits a copy of the reviewed document. This may be accomplished in the same ways that information and document transmittal has been described previously, e.g., via direct uploading to the web page.

The central computer then stores a copy of the final, reviewed document, referenced by job number, at point 100. Using the word count generated at point 98, the central computer generates pay statements for the typist and proofreader, and billing statements for the user, as indicated at point 112.

It is to be appreciated that the use of a web page interface as described not only facilitates remote access of the system by users and processing personnel, but also by system managers. For example, using the functions and programs described above, one of skill in the art would be able to program the system to allow remote management of the system, performing such functions as Adding, Editing and Deleting users and processing personnel; Viewing all incomplete jobs by categories such as unassigned to typist, assigned to typist, unassigned to proofreader, assigned to proofreader; and Moving “assigned to typist” and “assigned to proofreader” documents into their respective unassigned queues. Similarly, system users would be able to use the web page to upload templates, scanned signatures, and other “boiler-plate” documents, or to Add, Edit and Delete entries from the user's address book. This would allow the user to refer to these items during dictation, then permit typists, proofreaders, and shipping personnel to access the items is preparing and reviewing documents.

After the drafts are satisfactory to the user, the user can relay instructions (as described with reference to points 46 through 50) for the final document to be printed, signed, and packaged for distribution either electronically or via a delivery service. In the example of a user employing a handheld wireless telephonic device such as a having internet capabilities, it is contemplated that the same device could be used to transmit the original user information and receive the finished document. Alternatively, the user could retrieve the document via a computer internet connection, or have the finished document received by a central office in another location.

It can be seen from the foregoing that the present invention is susceptible to variation. For instance, it is contemplated that the “telephonic” connections described herein are not limited to standard telephone lines, but could be provided as ISDN lines or other higher-speed connections. Furthermore, the steps involving entering dictation could be accomplished via high-speed playback, if the user and central computer were provided with suitable known equipment. There is a wide variety of commercially available software that will allow entry and use of credit cards on line which could be employed to accomplish billing tasks. Similarly, commercially available software could provide for secure encryption and transmission of sensitive or confidential documents and information. The present invention, as defined by the appended claims, provides a full-time offsite source of word processing. It provides users with a virtually unlimited staff of qualified word processors for which the user pays on an “as-needed” basis.

Although the present invention has been described with reference to specific embodiments, those of skill in the art will recognize that changes may be made thereto without departing from the scope and spirit of the invention.

1. A method of producing a document at a remote typing station using information input from a remote user location, the method comprising the following steps:
establishing a telephonic connection between a user location and a central computer;
establishing a connection between the typing station and the central computer;
entering voice user information from the user location into the central computer via the telephonic connection;
entering image user information from the user location into the central computer via the telephonic connection;
receiving and storing the input user information in the central computer;
generating a notification signal to a remote typing station indicating that user information has been received;
retrieving input user information, at the typing station, from the central computer;
producing a document at the typing station using the user information from the central computer, the document including the image information correlated with the verbal information;
transmitting the document from the typing station to the central computer;
receiving and storing the document in the central computer;
establishing a connection between a destination location and the central computer; and
transmitting the document from the central computer to the destination location.

2. A method according to claim 1, wherein the step of entering image information from the user location into the central computer via the telephonic connection comprises entering digital image data into the central computer.

3. A method according to claim 2, wherein the step of entering image information from the user location into the central computer via the telephonic connection comprises entering digital image data into the central computer via a hand-held phone/camera device.

4. A method according to claim 1, wherein the step of establishing a telephonic connection between the typing station and the central computer comprises establishing an internet connection between the typing station and the central computer.

5. A method according to claim 4, wherein the step of retrieving input information, at the typing station, from the central computer comprises downloading input information to the typing station via the internet connection using streaming.

6. A method according to claim 4, wherein the step of transmitting the document from the typing station to the central computer via the telephonic connection comprises uploading input information from the typing station via the internet connection.

7. A method according to claim 1, wherein the step of establishing a telephonic connection between the user location and the central computer comprises establishing an internet connection between the user location and the central computer.

8. A method according to claim 7, wherein the step of transmitting the document from the central computer to the user location via the telephonic connection comprises downloading the document via the internet connection.

9. A method according to claim 8, wherein the step of transmitting the document from the central computer to the user location via the telephonic connection comprises e-mailing the input information to the user via the internet connection.

10. A method of producing a document at a remote typing station using information input from a remote user location, the method comprising the following steps:
establishing a telephonic connection between a user location and a central computer;
entering voice and image information from the user location into the central computer via the telephonic connection;
receiving and storing the input information in the central computer;
generating a notification signal to a remote typing station indicating that information has been received;
establishing a telephonic connection between the typing station and the central computer;
retrieving input information, at the typing station, from the central computer;
producing a document at the typing station using the information from the central computer;
transmitting the document from the typing station to the central computer via the telephonic connection;
generating a notification signal to a remote proofreading station indicating that information has been received;
establishing a telephonic connection between the proofreading station and the central computer;
retrieving the document, at the proofreading station, from the central computer;
processing the document at the proofreading station to produce a final document;
transmitting the final document from the proofreading station to the central computer via the telephonic connection;
receiving and storing the final document in the central computer;
establishing a telephonic connection between the user location and the central computer; and
transmitting the final document from the central computer to the user location via the telephonic connection.

11. A method according to claim 10, wherein the step of processing the document at the proofreading station to produce a final document comprises reviewing the document to identify errors in spelling, grammar, or content, and correcting any such errors that are identified.

12. A method according to claim 10, wherein the step of entering image information from the user location into the central computer via the telephonic connection comprises entering digital image data into the central computer.

13. A method according to claim 10, wherein the step of entering information from the user location into the central computer via the telephonic connection comprises entering faxed material into the central computer.

14. A method according to claim 10, wherein the step of establishing a telephonic connection between the typing station and the central computer comprises establishing an internet connection between the typing station and the central computer.

15. A method according to claim 14, wherein the step of retrieving input information, at the typing station, from the central computer comprises downloading input information to the typing station via the internet connection.

16. A method according to claim 14, wherein the step of transmitting the document from the typing station to the central computer via the telephonic connection comprises

17. A method according to claim 10, wherein the step of establishing a telephonic connection between the user location and the central computer comprises establishing an internet connection between the user location and the central computer.

18. A method according to claim 17, wherein the step of transmitting the document from the central computer to the user location via the telephonic connection comprises uploading the document via the internet connection.

19. A method according to claim 18, wherein the step of transmitting the document from the central computer to the user location via the telephonic connection comprises e-mailing the input information to the user via the internet connection.

20. A method according to claim 10, wherein the step of establishing a telephonic connection between the proofreading station and the central computer comprises establishing an internet connection between the proofreading station and the central computer.
